(19) United States
(12) Patent Application Publication
(10) Pub. No.: US 2011/0112951 A1
(43) Pub. Date: May 12, 2011

(54) METHOD AND SYSTEM FOR LOCAL CURRENCY BACKED BY A VALUABLE ASSET

(76) Inventor: James Gould, Kensington, NH (US)

(21) Appl. No.: 12/614,889

(22) Filed: Nov. 9, 2009

(51) Int. Cl. G06Q 40/00

(52) U.S. Cl. 705/37

(57) ABSTRACT

A local currency system and method are disclosed, the system and method providing for partially backing a local currency with a valuable asset. The currency system includes a local currency and a currency issuer. The currency issuer issues the local currency in an issuing exchange for legal tender, and purchases the valuable asset with at least a portion of the legal tender received in the issuing exchange. The valuable asset is held by the currency issuer, and can be sold by the currency issuer to cover a redemption exchange where the currency issuer receives the local currency and disburses the legal tender. The currency issuer can include one or more automated teller machines configured to perform the issuing and redemption exchanges. The currency issuer can have a computer system with a database configured to track the issuing and redemption exchanges, and regulate purchasing and selling of the valuable asset.

### FIELD OF THE INVENTION

The invention generally relates to currency systems, and more specifically to local currency systems.

### BACKGROUND OF THE INVENTION

There are several types of currency systems including: (1) fiat currency, (2) representative money, (3) commodity money and (4) local currency. The U.S. dollar is currently a fiat currency, which means that the U.S. dollar's foundational value is derived from the U.S. government declaring the dollar legal tender to pay any taxes and debt in the United States. Supply of a fiat currency depends almost exclusively on the discretionary powers of the currency issuer issuing the fiat currency. Since there is little direct economic restraint on printing and issuance of additional amounts of a fiat currency, the value of a fiat currency may depreciate if there is oversupply of the fiat currency or if confidence in the currency issuer is reduced. Depreciation in the fiat currency leads to reduced buying power of products and services with the fiat currency. Thus, for a fiat currency to maintain its value, a currency issuer must carefully manage supply of the currency, thereby maintaining a high level of confidence in the currency.

Commodity money is a currency made of a valuable physical commodity asset, such as gold, which provides the currency's foundational value. Representative money is a currency that is redeemable for a predetermined amount of a valuable asset such as a physical commodity like gold. The U.S. dollar for most of its early history was a representative money currency and/or a commodity money currency. Under such currency systems, a currency issuer can only issue currency as long they have sufficient amounts of the physical commodity to produce or redeem the currency in circulation, as well as any additional currency the currency issuer wishes to issue. These currency systems provide a more stable currency value than fiat currency. Even if supply of a commodity or representative currency is increased, or confidence in the currency issuer diminishes, the commodity or representative money will remain stable so long as the currency issuer is trusted to maintain the valuable asset holdings for the representative money. However, such a system has the disadvantage of requiring that the issuer acquire significant amounts of the valuable asset having an equivalent value to the issued currency and, for representative money, warehousing of these significant amounts of the valuable asset.

Another type of currency is a local currency that may be circulated within a specific locality in an effort to stimulate local commerce. Such a currency is pegged at a fixed exchange rate to the legal tender of the country in which the locality resides, and is issued by a private organization unrelated to the government. Consumers may be encouraged by the local currency issuer to exchange legal tender for the local currency by offering the local currency at a discounted exchange rate. Merchants within the locality can agree to accept the local currency at the fixed exchange rate, thereby providing consumers with a discount for using local currency instead of legal tender in transactions with these merchants within the locality. Merchants can be encouraged to use the local currency to make purchases from other local merchants who have also agreed to accept the currency rather than exchanging the local currency for legal tender by providing a redemption exchange rate that is below the discounted exchange rate to the consumer. However, consumers and merchants might be reluctant to accept and accumulate the local currency if they do not have confidence in the private organization issuing the currency. Moreover, a newly formed private organization without any reputation may have a difficult time gaining acceptance of the local currency they wish to issue.

### SUMMARY OF THE INVENTION

The present invention provides a system and method for a local currency that provides for partially backing the currency with a valuable asset. In this manner, the local currency system and method according to the present invention may provide stability and confidence in the value of the local currency not found in existing local currencies. It also can provide the advantage of not requiring large initial investments in valuable asset to back the local currency, but rather allowing for using the inflows of legal tender to provide the valuable asset investment resources.

In one embodiment of the currency system according to the present invention, the currency system includes a local currency being circulated within only a portion of a governmental jurisdiction that issues a legal tender. The local currency is only partially backed with a valuable asset. The local currency is issued in exchange for legal tender at a first exchange rate of local currency to legal tender, and redeemed with legal tender at a second exchange rate of local currency to legal tender, where the second exchange rate is lower than the first exchange rate.

In one alternative exemplary embodiment of the currency system according to the present invention, a predetermined physically measurable quantity of the valuable asset is purchased at a time when an amount of the legal tender accumulated is sufficient to purchase the predetermined physically measurable quantity of the valuable asset. In another alternative exemplary embodiment of the currency system according to the present invention, a predetermined physically measurable quantity of the valuable asset is purchased at a time when an amount of legal tender accumulated is a predetermined ratio above the purchase price of the predetermined physically measurable quantity of the valuable asset. In certain embodiments, the predetermined ratio of legal tender accumulated to the purchase price of the valuable asset for when the currency issuer purchases the valuable asset can be 2:1.

In another alternative exemplary embodiment of the currency system according to the present invention, the local currency is partially backed with the valuable asset before the local currency is issued in exchange for the legal tender at the first exchange rate.

In some embodiments of the invention, the local currency can be issued exclusively by an entity of the private sector, while in other embodiments, the local currency can be issued exclusively by a non-profit organization.

In one alternative exemplary embodiment of the currency system according to the present invention, the valuable asset is gold. In other alternative exemplary embodiments, the local currency can take the form of a printed paper bill.

In some preferred embodiments of the invention, the local currency can be exchanged by an automated teller machine that is configured to provide the local currency in exchange for the legal tender, and to provide the legal tender in exchange for the local currency. In some other embodiments, a computer system is configured to purchase the valuable asset in proportion to an amount of local currency to be issued.

In one alternative exemplary embodiment of the invention, the first exchange rate is a ratio of a discounted value of the local currency, to a goods and services exchange rate value of the local currency.

In another embodiment of the invention, the currency system includes a local currency, the local currency being circulated at least as paper bills within only a portion of a governmental jurisdiction that issues a legal tender, and the local currency being only partially backed by gold by purchasing a predetermined physically measurable quantity of gold, the purchasing being at a time when an amount of the legal tender accumulated is a predetermined ratio above the purchase price of the predetermined physically measurable quantity of gold. In this embodiment the local currency is issued in exchange for the legal tender at a first exchange rate of the local currency to the legal tender, and it is redeemed with the legal tender at a second exchange rate of the local currency to the legal tender that is lower than the first exchange rate.

In another alternative embodiment of the invention, a method of operating a local currency system comprises issuing a local currency in exchange for legal tender at a first exchange rate of local currency to legal tender, purchasing a valuable asset so as to back, with the valuable asset, a portion less than an entire value of the local currency at time of issue of the local currency, and redeeming the local currency with the legal tender at a second exchange rate of local currency to legal tender lower than the first exchange rate.

In some of these embodiments, the purchased valuable asset is of a predetermined physically measurable quantity, and purchasing the valuable asset is performed only at a time when an amount of the legal tender accumulated is sufficient to purchase the predetermined physically measurable quantity of the valuable asset.

In other embodiments, the purchased valuable asset is of a predetermined physically measurable quantity, and purchasing the valuable asset is performed only at a time when an amount of legal tender accumulated is a predetermined ratio above a purchase price of the predetermined physically measurable quantity of the valuable asset.

In another alternative embodiment of the invention, the currency system comprises a computer-readable medium containing a computer program for configuring a computer to perform the above methods of operating a local currency system in accordance with the invention.

In other alternative embodiments of the invention, the methods of operating a local currency system further include authorizing an issuance amount of the local currency prior to issuing the local currency, purchasing additional amounts of the valuable asset prior to issuing the local currency, if completion of the issuing of the local currency would cause an issued amount of the local currency to exceed the authorized issuance amount, and increasing the authorized issuance amount, if the purchasing of additional amounts of the valuable asset is performed.

In some embodiments of the method of operating a local currency system in accordance with the invention, the first exchange rate is a ratio of a discounted value of the local currency, to a goods and services exchange rate value of the local currency.

In other embodiments, the method of operating a local currency system in accordance with the invention further comprises disbursing a profit from gains realized in redeeming the local currency.

### BRIEF DESCRIPTION OF THE DRAWINGS

The invention will be more fully understood by reference to the detailed description, in conjunction with the following figures, wherein:

FIG. 1 illustrates an exemplary embodiment of a local currency system according to the present invention;

FIG. 2 illustrates an exemplary embodiment of a method of issuing a local currency and purchasing a valuable asset for backing the local currency according to the present invention;

FIG. 3 illustrates an alternative exemplary embodiment of a method of issuing the local currency and purchasing the valuable asset for backing the local currency;

FIG. 4 illustrates an exemplary embodiment of a method for redeeming the local currency;

FIG. 5 illustrates an exemplary mode of a currency issuer issuing or redeeming local currency according to the present invention; and

FIG. 6 illustrates another exemplary mode of a currency issuer issuing or redeeming local currency according to the present invention.

### DETAILED DESCRIPTION OF PREFERRED EMBODIMENTS

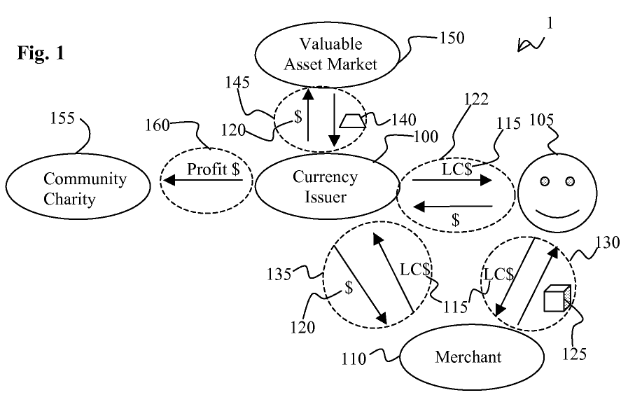

FIG. 1 illustrates an exemplary embodiment of a local currency system 1 according to the present invention. The local currency system 1 has a currency issuer 100. The currency issuer 100 issues local currency 115 to a consumer 105 in an issuing exchange 122 for legal tender 120. In a redemption exchange 135 with a merchant 110 or anyone in possession of local currency, the currency issuer 100 redeems the local currency 115 for the legal tender 120. Based upon certain parameters regarding an amount of the legal tender 120 accumulated by the currency issuer 100 or based upon an amount of the local currency 115 issued by the currency issuer 100, the currency issuer 100 purchases a valuable asset 140 in a valuable asset exchange 145 for the legal tender 120. The currency issuer 100 can also disburse an amount of the legal tender 120 deemed to be profit in a profit transaction 160 to a community charity 155.

The currency issuer 100 can be comprised of a computer system with a database. The computer system can be configured to track and/or execute the issuing exchange 122, the redemption exchange 135, the valuable asset exchange 145, and the profit transaction 160. The computer system can be additionally configured to maintain an accounting of the legal tender 120, the local currency and valuable asset holdings of the currency issuer 100. The currency issuer 100 can also be further comprised of a one or more local currency exchange points where the local currency 115 is available for the issuing exchange 122 and/or the legal tender 120 is available for the redemption exchange 135. The currency issuer 100 can also have communication links between the local currency exchange points and the server as well as communication links to perform transactions with a valuable asset market 150 and the community charity 165. The local currency exchange points can be storefronts and automated teller machines. Alternatively, the local currency exchange points can be independent entities from the currency issuer 100, such as banks or independently owned and managed storefronts.

The currency issuer 100 is preferably an entity that is independent from any government entity. In other words, the currency issuer 100 is neither owned nor managed by a government entity. Moreover, the currency issuer 100 can be structured as a non-profit organization that is operated exclusively for charitable or other non-profit purposes deemed proper under the law.

The local currency 115 can be paper bills issued in denominations such as 1, 5, 10, 20, 50 and 100 and the paper bills can be printed in a form that prevents forgery. The denominations on the local currency 115 are, preferably, indicative of an equivalent value of the legal tender 120. Alternatively, the local currency 115 can be issued in a gift card type format or electronic money card or can be credited to an account with the currency issuer 100 or at an independent entity such as a bank.

The legal tender 120 is any currency denominated as such by a government entity within which the currency issuer 100 is located. The legal tender 120, according to the present invention, is not necessarily limited to the actual physical currency of the government entity within which the currency issuer 100 is located but can also include proffering the equivalent funds by check, debit card, credit card or any non-cash methods of payment. The currency issuer 100 may also be capable of accepting another currency that is not the legal tender 120 by first calculating an exchange of the other currency into the legal tender 120 and then exchanging the calculated amount of the legal tender 120 into the local currency 115.

The valuable asset exchange 145 can be transacted with or through the valuable asset market 150 which can be, for example, a commodity exchange. The valuable asset 140 is preferably a precious metal such as gold that is acquired in physically measurable determinate amounts such as 1 oz gold coins. In the valuable asset exchange 145, the currency issuer 100 preferably has the valuable asset 140 that has been purchased delivered to a local bank to be held in trust. An audit of the amounts of the valuable asset 140 held in the trust can be performed on a periodic basis, such as every three months, and the results of the audit can be made public.

The consumer 105 can be any entity or person that is capable of proffering the legal tender 120 for the issuing exchange 122 for the local currency 115. The merchant 110 can be any entity or person who has agreed to accept the local currency 115 as payment for goods or services 125 in a commerce exchange 130. There can be multiple consumers 105 and merchants 110.

Preferably, the merchant 110 accepts the local currency 115 from the consumer 105 at a fixed commerce exchange rate and one that values the local currency 115 at a fixed exchange rate of one-to-one in the commerce exchange 130. The issuing exchange 122 is preferably transacted at an issuing exchange rate that sets the local currency 115 at a lower value than in the commerce exchange 130. In other words, the consumer 105, preferably, realizes a discount in the commerce exchange 130 over an equivalent transaction using the legal tender 120. Furthermore, the redemption exchange 135 is preferably transacted at a redemption exchange rate that sets the local currency 115 at a lower value than in the issuing exchange. In other words, the merchant 110, preferably, by redeeming the local currency 115 for the legal tender 120 realizes a further loss in the value of the local currency 115 in addition to the discount received by the consumer in the issuing exchange 122. The merchant 110, instead of entering into the redemption exchange with the currency issuer 100 can, alternatively, act as the consumer 105 with other merchants 110 and use the local currency 115 in a commerce exchange 130, thereby realizing no loss in the value of the local currency 115 relative to the legal tender 120.

The following exemplary scenario illustrates how the value of the local currency 115 can vary between the issuing exchange 122, the commerce exchange 130, and the redemption exchange 135. In the United States, the consumer 105 can, for example, proffer US$97.50 to the currency issuer 100 in exchange for LC$100 (LC$ is defined as local currency denomination). The consumer 105 can then use the LC$100 to purchase in the commerce exchange 130 a product or service from the merchant 110 that is priced at US$100. Thus, the consumer 105 realizes a 2.5% savings by performing the commerce exchange 130 with the local currency 115 rather than the equivalent transaction with U.S. Dollars. The merchant 110 can then exchange the LC$100 for U.S. dollars in the redemption exchange 135 for US$95. Thus, the merchant realizes a 5% loss on the equivalent transaction with U.S. Dollars. Alternatively, the merchant 110 can use the LC$100 to purchase US$100 worth of goods and services from another merchant 110.

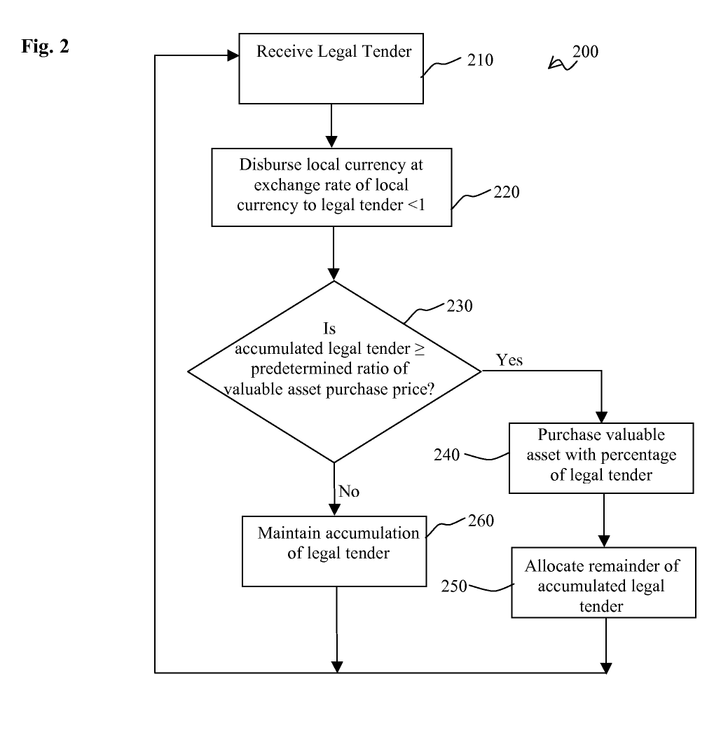

The present invention provides a method for partially backing the local currency 115 with the valuable asset 140. FIG. 2 illustrates an exemplary embodiment of a post-issue method 200 of issuing the local currency 115 and purchasing the valuable asset 140 for backing the local currency 115 according to the present invention. In other words, the exemplary post-issue method 200 of FIG. 2 illustrates one possible manner of regulating the purchase of the valuable asset 140, i.e. the valuable asset exchange 145, relative to the issuing exchange 122.

In step 210 of the post-issue method 200, the currency issuer 100 receives an amount of the legal tender 120 from the consumer 105. The currency issuer 100 then in step 220 disburses an amount of the local currency 115 to the consumer 105. The amount of the local currency 115 disbursed in step 220 is a function of the amount of legal tender 120 received by the currency issuer 100 in step 210 and the issuing exchange rate. As discussed above, the valuation of the local currency 115 in the issuing exchange rate should preferably be lower than the valuation of the local currency 120 in the commerce exchange rate. Thus, if as discussed above, the valuation of the local currency 115 in the commerce exchange rate is preferably at a one-to-one ratio of the local currency 115 valuation to the legal tender, then the issuing exchange rate of the local currency to the legal tender is less than 1 as is shown in step 220 in FIG. 2.

In step 230, it is determined if an amount of the legal tender 120 accumulated by the currency issuer 100 (accumulated legal tender) after one or more iterations of the step 210, receiving the legal tender 120, is greater than or equal to a predetermined ratio above a purchase price for the valuable asset 140. For example, the predetermined ratio of the accumulated legal tender to the purchase price of the valuable asset can be 2 and the valuable asset can be 1 oz. gold coins each with a purchase price of US$1000. When the currency issuer 100 accumulates US$2000, the post-issue method 200 proceeds to step 240. Otherwise, the method can proceed to a step 260 where the currency issuer 100 maintains an accounting of the amount of the legal tender 120 for a future iteration of the post-issue method 200. The predetermined ratio for accumulating the legal tender 120 above the purchase price of the valuable asset 140 is preferably a value greater than one.

In step 240, the currency issuer 100 purchases the valuable asset 140 with a percentage of the accumulated legal tender. The percentage of the accumulated legal tender that is expended in purchasing the valuable asset 140 can be 100%, the inverse of the predetermined ratio of the accumulated legal tender to the purchase price from Step 230, or any other value deemed appropriate by the currency issuer 100 that provides backing for a portion of the value of the local currency 115 issued for the corresponding accumulated legal tender. The currency issuer 100 can then fix the physically measurable amount of the valuable asset 140 that backs the corresponding accumulated legal tender at or below the physical amount of the valuable asset 140 purchased. The remainder of the accumulated legal tender, not used for purchasing the valuable asset 140 can then be allocated or transferred to a reserve account in Step 250.

To illustrate, if the percentage of the accumulated legal tender that is expended in purchasing the valuable asset 140 is 50% and the currency issuer 100 has accumulated US$2000 for issuing LC$2000, then the currency issuer 100 expends US$1000 purchasing the valuable asset 140. If the valuable asset is a 1 oz. gold coin, then the currency issuer 100 can fix the amount of gold backing the particular LC$2000 issued for the accumulated US$2000 at 1 oz. The remaining US$1000 of the accumulated legal tender is then allocated or transferred to a reserve account.

Alternatively, if the percentage of the accumulated legal tender that is expended in purchasing the valuable asset 140 is 100%, then the currency issuer 100 expends the entire US$2000 of the accumulated legal tender purchasing two times the valuable asset 140. If the valuable asset is two 1 oz. gold coins, then the currency issuer 100 can fix the amount of gold backing the particular LC$2000 issued for the accumulated US$2000 at 2 oz. The currency issuer 100 can, alternatively, fix the amount of gold backing the particular LC$2000 issued at 1 oz. and use the remaining gold to back further issuance of the local currency 115, i.e. a hybrid of the post-issue method and a pre-issue method 300 discussed below, or can allocate the additional physical amount of the valuable asset 140 as reserve.

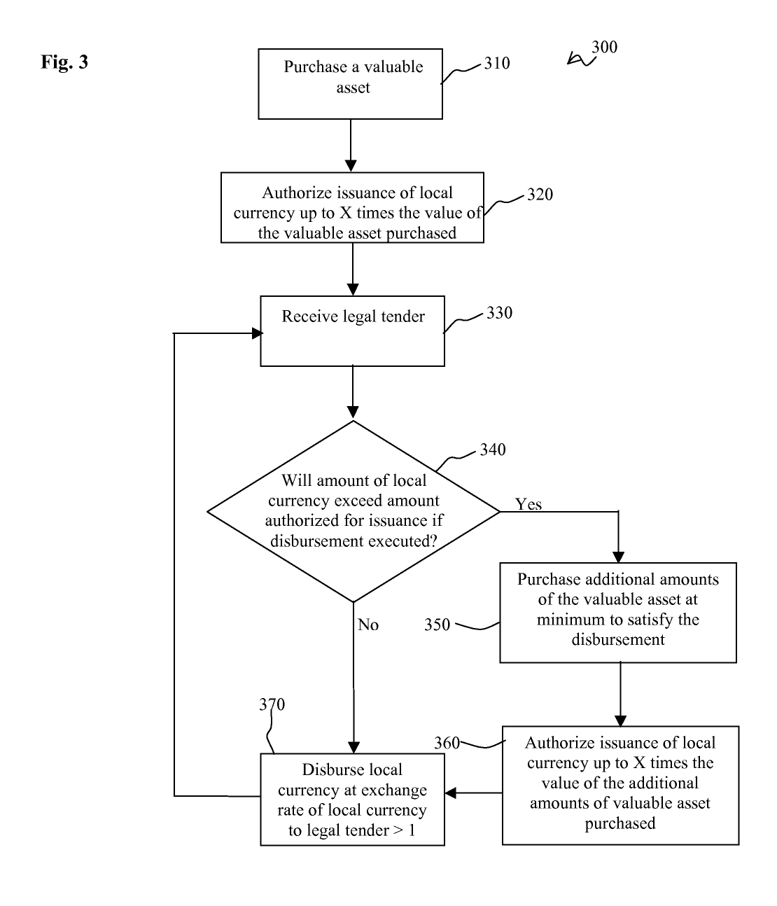

FIG. 3 illustrates an exemplary embodiment of a pre-issue method 300 of issuing the local currency 115 and purchasing the valuable asset 140 for backing the local currency 115 according to the present invention. In other words, the exemplary pre-issue method 300 of FIG. 3 illustrates another possible manner of regulating the purchase of the valuable asset 140, i.e. the valuable asset exchange 145, relative to the issuing exchange 122.

In step 310 of the post-issue method 200, the currency issuer 100 purchases an initial amount of the valuable asset 140. For example, the valuable asset can be 1 oz. gold coins valued at US$800 a piece. The currency issuer 100 in step 310 can initially purchase five of the 1 oz. gold coins to expend a total of US$4000.

In step 320, the currency issuer 100 authorizes issuance of an amount of the local currency 115 up to a certain number of times above the value of the initial amount of the valuable asset 140 purchased in step 310. For example, the currency issuer 100 can authorize issuance of twice the value of the amount of the valuable asset 140 initially purchased. Thus, if the currency issuer 100 purchased US$4000 worth of the valuable asset 140 presuming a one-to-one commerce exchange rate valuation of the legal tender 120 to the local currency 115, the currency issuer 100 would authorize issuance of LC$8000.

In step 330, the currency issuer 100 receives the legal tender 120 from the consumer 105 as part of the issuing exchange 122. Then in step 340, the currency issuer 100 determines if disbursing the amount of the local currency 115 necessary to complete the issuing exchange 122 would exceed the amount of the local currency 115 authorized for issuance. If the amount of the local currency 115 authorized for issuance will not be exceeded, the pre-issue method 300 proceeds to step 370. Otherwise, the pre-issue method 300 proceeds to step 350. For example, if the amount of the local currency 115 authorized for issuance is LC$8000 and the currency issuer 100 has received in step 330 a sufficient amount of the legal tender 120 to require disbursement of LC$9000 at the issuing exchange rate to complete the issuing exchange 122, then the pre-issue method 300 proceeds to step 370.

In step 350, the currency issuer 100 purchases additional amounts of the valuable asset 140. The currency issuer 100 can purchase only a sufficient amount to complete the issuing exchange 122. Alternatively, the currency issuer 100 can purchase a larger amount of the valuable asset 140 to satisfy future issuing exchanges 122 as well. For example, if the amount of the local currency 115 authorized for issuance is LC$8000 and the currency issuer 100 requires LC$9000 to complete the issuing exchange 122, the currency issuer 100 needs to purchase additional amounts of the valuable asset 140. If the currency issuer 100 backs the local currency 115 with a valuable asset 140 worth 50% of the local currency value at time of issue and there is a one-to-one valuation between the local currency and the legal tender 120 at the commerce exchange, then the currency issuer 100 need only purchase US$500 worth of the valuable asset 140. The currency issuer 100 can, alternatively, purchase a larger amount of the valuable asset 140 such as US$4000 worth, enough at 50% of issue valuation backing to issue LC$8000.

In step 360, the currency issuer 100 adds to the amount of the legal tender 120 authorized for issuance as a function of the amount of the valuable asset 140 purchased in step 350. Thus, assuming that the currency issuer 100 currently authorizes issuance of LC$8000 and there is a one-to-one valuation between the local currency 115 and the legal tender 120 at the commerce exchange 130, then if the currency issuer 100 backs 50% of the local currency 115 value at issue and the currency issuer 100 purchased US$4000 worth of the valuable asset, then the currency issuer 100 can add LC$8000 to the amount of the local currency 115 authorized for issuance, for a total of LC$16000 authorized for issuance.

In step 370, the currency issuer 100 disburses the local currency 115 to the consumer 105. The currency issuer 100 calculates the amount of the local currency 115 to be disbursed by multiplying the amount of the legal tender 120 received by the issuing exchange rate. As discussed above, it is preferable that the issuing exchange rate be computed with a discounted valuation of the local currency 115 relative to the commerce exchange rate valuation of the local currency 115. Thus, if there is a one-to-one valuation between the local currency 115 and the legal tender 120 in the commerce exchange 130, then the issuing exchange rate is preferably greater than one. When the currency issuer 100 disburses the local currency 115, the currency issuer 100 also adjusts the amount of the local currency 115 authorized for issuance by subtracting the amount of the local currency 115 disbursed. After step 370, the method returns to step 330 for another issuing exchange to be initiated. To illustrate, assume that the currency issuer 100 provides a 2.5% discount on the local currency 115 issued in the issuing exchange and there is a one-to-one valuation of the local currency 115 to the legal tender 120 at the commerce exchange 130. If the currency issuer 100 received US$975 in step 330, then the currency issuer 100 will disburse LC$1000 and subtract LC$1000 from the amount of the local currency 115 authorized for issuance.

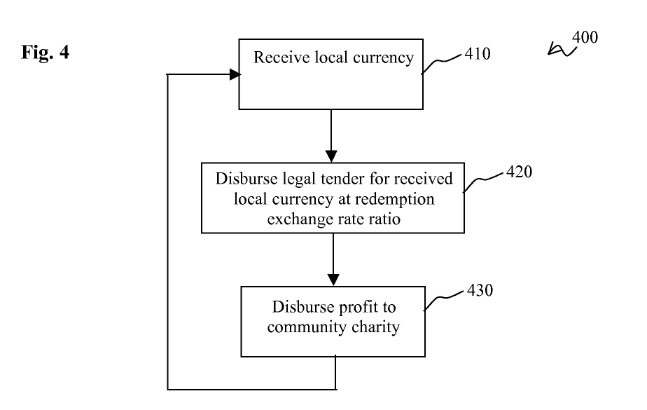

FIG. 4 illustrates an exemplary embodiment of a redemption method 400 for redeeming the local currency 115 that is in circulation. In step 410, the currency issuer 100 receives an amount of the local currency 115. In step 420, the currency issuer 100 disburses an amount of the legal tender 120 for the local currency 115 received in step 410 as a function of the redemption exchange rate. As discussed above, the redemption exchange rate preferably provides a discounted valuation of the local currency 115 relative to the issuing exchange rate valuation of the local currency 115. Thus, if the currency issuer 100 provides a 2.5% discount on the local currency 115 in the issuing exchange 122, then the currency issuer 100 can provide, for example, another 2.5% discount on the valuation of the local currency 115 in the redemption exchange 135, for a total discount of 5% over the local currency 115 valuation in the commerce exchange 130. Therefore, if the currency issuer 100 received LC$1000 in step 410, then the currency issuer 100 will disburse US$950 in step 420, assuming a one-to-one valuation of the local currency 115 to the legal tender 120 in the commerce exchange 130.

Generally, there should be sufficient amounts of the legal tender 120 held in reserve to cover the disbursement for the redemption exchange 135. Nevertheless, it is possible that in order to cover the disbursement of the legal tender 120 in step 420, the currency issuer 100 may have to sell an amount of the valuable asset 140. However, the physically measurable amount of the valuable asset 140 sold to cover the disbursement of the legal tender 120 should not be greater than the physically measurable amount of the valuable asset 140 purchased to back the particular local currency 120 when it was originally issued. Thus, if the currency issuer 100 receives LC$1000 to be redeemed which was originally backed by ½ oz of gold around the time the local currency 120 was originally issued, i.e. pre- or post-issue, then the currency issuer 100 may only sell ½ oz. of gold to cover the disbursement of the legal tender 120 in the redemption exchange 135. Alternatively, the currency issuer 100 as a matter of course can sell the physically measurable amount of the valuable asset 140 initially purchased to back the particular local currency 115. Any deficiency in funds to cover the disbursement of the legal tender 120 should be absorbed by a legal tender reserve. Another possibility is for the currency issuer 100 to retain the valuable assets 140 and increase the amount of the local currency 115 authorized to be issued.

In step 430, the currency issuer 100 disburses the profits of the currency issuer 100 to the community charity 155. The profits can be limited to certain profits such as the difference between the price paid for the local currency 115 by the consumer minus the amount paid by the currency issuer 100 to the merchant 110 for redeeming the local currency 115. Additionally, profits from realized gains from selling the valuable assets 140 held by the currency issuer 100 might be deemed profit or allocated to a legal tender reserve. Of course, operating expenses can be deducted from these profits before disbursing the funds to the community charity 155.

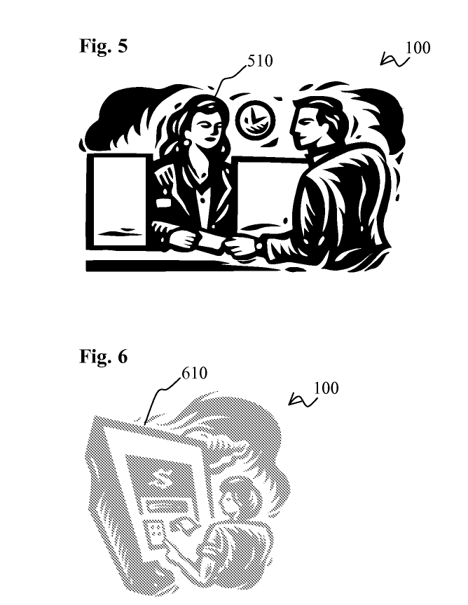

FIG. 5 illustrates an exemplary mode of a currency issuer 100 issuing or redeeming the local currency 115 according to the present invention. The currency issuer 100 can be comprised of a teller 510, who has an amount of the local currency 115 and legal tender 120 so as to be able to handle issuing and redeeming exchanges 122, 135. The teller 510 can have a computer that communicates with a central computer of the currency issuer 100 that has a database to track issuing and redeeming exchanges 122, 135 from the teller 510 and to regulate purchases and sales of the valuable asset 140. The currency issuer 100 can also be comprised of one or more automated teller machines 610 as illustrated in FIG. 6. The automated teller machine 610 can have an amount of the local currency 115 and legal tender 120 so as to be able to handle issuing and redeeming exchanges 122, 135. The automated teller machine 610 is similar to those found in the art that dispense the legal tender 120 and accept the legal tender 120 or checks for deposit. The automated teller machine 610 has the capability either through an additional output slot to dispense the local currency 115 or by selectively outputting the legal tender 120 and the local currency 115 through the same slot.

Other modifications and implementations will occur to those skilled in the art without departing from the spirit and the scope of the invention as claimed. Accordingly, the above description is not intended to limit the invention except as indicated in the following claims.

What is claimed is:

1. A currency system, comprising:
a local currency,
the local currency being circulated within only a portion of a governmental jurisdiction that issues a legal tender,
the local currency being only partially backed with a valuable asset,
the local currency being issued in exchange for the legal tender at a first exchange rate of the local currency to the legal tender, and
the local currency being redeemed with the legal tender at a second exchange rate of the local currency to the legal tender that is lower than the first exchange rate.

2. The currency system of claim 1, wherein the local currency being only partially backed with a valuable asset includes:
backing the local currency by purchasing a predetermined physically measurable quantity of the valuable asset, the purchasing being at a time when an amount of the legal tender accumulated is sufficient to purchase the predetermined physically measurable quantity of the valuable asset.

3. The currency system of claim 1, wherein the local currency being only partially backed with a valuable asset includes:
backing the local currency by purchasing a predetermined physically measurable quantity of the valuable asset, the purchasing being at a time when an amount of the legal tender accumulated is a predetermined ratio above the purchase price of the predetermined physically measurable quantity of the valuable asset.

4. The currency system of claim 3, wherein the predetermined ratio above the purchase price is 2:1.

5. The currency system of claim 1, wherein the local currency is partially backed with the valuable asset before the local currency is issued in exchange for the legal tender at the first exchange rate.

6. The currency system of claim 1, wherein the local currency is issued exclusively by an entity of the private sector.

7. The currency system of claim 1, wherein the local currency is issued exclusively by a non-profit organization.

8. The currency system of claim 1, wherein the valuable asset is gold.

9. The currency system of claim 1, wherein the local currency can take the form of a printed paper bill.

10. The currency system of claim 1, wherein the local currency can be exchanged by an automated teller machine that is configured to provide the local currency in exchange for the legal tender, and to provide the legal tender in exchange for the local currency.

11. The currency system of claim 1, wherein a computer system is configured to purchase the valuable asset in proportion to an amount of local currency to be issued.

12. The currency system of claim 1, wherein the first exchange rate is a ratio of:
a discounted value of the local currency, to
a goods and services exchange rate value of the local currency.

13. A currency system, comprising:
a local currency,
the local currency being circulated at least as paper bills within only a portion of a governmental jurisdiction that issues a legal tender,
the local currency being only partially backed by gold by purchasing a predetermined physically measurable quantity of gold, the purchasing being at a time when an amount of the legal tender accumulated is a predetermined ratio above the purchase price of the predetermined physically measurable quantity of gold,
the local currency being issued in exchange for the legal tender at a first exchange rate of the local currency to the legal tender, and
the local currency being redeemed with the legal tender at a second exchange rate of the local currency to the legal tender that is lower than the first exchange rate.

14. A method of operating a local currency system, comprising:
issuing a local currency in exchange for legal tender at a first exchange rate of local currency to legal tender;
purchasing a valuable asset so as to back, with the valuable asset, a portion less than an entire value of the local currency at time of issue of the local currency; and
redeeming the local currency with the legal tender at a second exchange rate of local currency to legal tender lower than the first exchange rate.

15. The method of claim 14, wherein the purchased valuable asset is of a predetermined physically measurable quantity, and
purchasing the valuable asset is performed only at a time when an amount of the legal tender accumulated is sufficient to purchase the predetermined physically measurable quantity of the valuable asset.

16. The method of claim 14, wherein the purchased valuable asset is of a predetermined physically measurable quantity, and
purchasing the valuable asset is performed only at a time when an amount of legal tender accumulated is a predetermined ratio above a purchase price of the predetermined physically measurable quantity of the valuable asset.

17. A computer-readable medium containing a computer program for configuring a computer to perform the method of claim 14.

18. The method of claim 14, further comprising the steps of:
authorizing an issuance amount of the local currency prior to issuing the local currency;
purchasing additional amounts of the valuable asset prior to issuing the local currency, if completion of the issuing of the local currency would cause an issued amount of the local currency to exceed the authorized issuance amount; and
increasing the authorized issuance amount, if the purchasing of additional amounts of the valuable asset is performed.

19. The method of claim 14, wherein the first exchange rate is a ratio of:
a discounted value of the local currency, to
a goods and services exchange rate value of the local currency.

20. The method of claim 14, further comprising:
disbursing a profit from gains realized in redeeming the local currency.
